(19) United States
(12) Patent Application Publication
(10) Pub. No.: US 2005/0159877 A1
(43) Pub. Date: Jul. 21, 2005

(54) Fault diagnosis device for detection device provided on engine

(76) Inventor: Kazutaka Hattori, Okazaki-shi (JP)

Correspondence Address: KENYON & KENYON, 1 BROADWAY, NEW YORK, NY, 10004, US

(21) Appl. No.: 11/035,104

(22) Filed: Jan. 14, 2005

(30) Foreign Application Priority Data
Jan. 16, 2004 (JP) 2004-009414(P)

(51) Int. Cl. G06F 7/00

(52) U.S. Cl. 701/107; 701/101

(57) ABSTRACT

An engine ECU executes a program including the steps of determining whether a combustion pressure in a specific cylinder is at least a predetermined value or not, determining whether there is an input from a crank angle sensor or not, detecting a lacking tooth, determining whether the lacking tooth is in a correct position or not, determining that the crank angle sensor is operating normally if the lacking tooth is in a correct position, and determining that the crank angle sensor is operating abnormally if the lacking tooth is not in the correct position.

This nonprovisional application is based on Japanese Patent Application No. 2004-009414 filed with the Japan Patent Office on Jan. 16, 2004, the entire contents of which are hereby incorporated by reference.

### BACKGROUND OF THE INVENTION

1. Field of the Invention

The present invention relates to a fault diagnosis device for a detection device provided on an engine for detecting a state of a shaft. More specifically, the present invention relates to a fault diagnosis device for diagnosing a fault in a detection device based on a pressure inside a combustion chamber of an engine.

2. Description of the Background Art

A detection device is conventionally provided on an engine to detect a state of a shaft which rotates with a driving force generated by combustion in a combustion chamber of the engine. A crank angle sensor, for example, detects a state of a rotation angle of a crankshaft. When the crank angle sensor becomes out of order, a number of revolutions of the engine cannot be determined, and therefore control based on the number of revolutions of the engine becomes difficult.

In view of the above-described problem, Japanese Patent Laying-Open No. 58-197452 discloses an electronic control device enabling ignition and fuel injection without a disturbance by a fault in the crank angle sensor. The electronic control device determines that the crank angle sensor is out of order when output of a signal from the crank angle sensor has stopped. In this situation, the electronic control device is constructed to detect a rotation speed of the engine from a drive state signal other than the signal from the crank angle sensor (for example, a signal of an air intake amount), and automatically switches to use a signal of a frequency corresponding to a value of the drive state signal as an ignition signal and an injection pulse.

According to the publication described above, stable operation over a broad range is possible even when the crank angle sensor becomes out of order.

In the publication described above, it is determined that the crank angle sensor is out of order when a signal from the crank angle sensor is not output. In addition, the publication discloses a method of detecting a rotation speed from the signal of the air intake amount in place of the signal from the crank angle sensor.

The electronic control device in the publication, however, which determines a fault by presence or absence of the output signal from the crank angle sensor and detects the rotation speed of the crankshaft based on the air intake amount, cannot detect an abnormal condition of the crank angle sensor such as a missing pulse or an excessive pulse caused by noise or the like, because discrimination of a cylinder and a rotation angle of the crankshaft are not known. In addition, an abnormal condition of the crank angle sensor cannot be determined based on the air intake amount when the air intake amount is small.

### SUMMARY OF THE INVENTION

An object of the invention is to provide a fault diagnosis device accurately detecting an abnormal condition of a crank angle sensor.

A fault diagnosis device according to the present invention is provided on an engine for diagnosing a fault in a detection device detecting a state of a shaft rotating with a driving force generated by combustion in a combustion chamber of the engine. The fault diagnosis device includes a pressure detection unit detecting a pressure inside the combustion chamber and a diagnosis unit diagnosing a fault in the detection device based on a state of the shaft analyzed based on a variation in a pressure detected with the pressure detection unit and a state of the shaft detected with the detection device.

According to the present invention, the fault diagnosis device is provided on an engine for diagnosing a fault in a detection device (for example, a crank angle sensor) detecting a state (for example, a state of a rotation angle) of a shaft (for example, a crankshaft) rotating with a driving force generated by combustion in a combustion chamber of the engine. The fault diagnosis device diagnoses a fault in the crank angle sensor by detecting an abnormal variation in a physical value according to rotation of the crankshaft, based on the pressure detection unit detecting a pressure inside the combustion chamber, a rotation angle analyzed based on a variation in the pressure detected with the pressure detection unit, and a rotation angle detected with the crank angle sensor. When the pressure detected with the pressure detection unit is at least a predetermined value, for example, the fault diagnosis device detects as to whether a predetermined input from the crank angle sensor is present or not. The diagnosis unit diagnoses that the crank angle sensor is out of order when the predetermined input is not present. More specifically, in the engine having a plurality of cylinders, for example, a variation in a pressure inside each cylinder due to combustion can be associated with a rotation angle of the crankshaft. Therefore, the diagnosis unit diagnoses a fault in the crank angle sensor based on a rotation angle of the crankshaft analyzed based on a time at which the pressure detected with the pressure detection unit reaches a maximum value (for example, a peak time of a combustion pressure) in a predetermined cylinder, and a rotation angle of the crankshaft based on a reference position (for example, a position of a lacking tooth of a timing rotor) detected with the crank angle sensor. The diagnosis unit diagnoses that the crank angle sensor is out of order when a difference between the rotation angle detected with the crank angle sensor and the rotation angle based on the combustion pressure is beyond a predetermined range. In addition, when the engine has a plurality of cylinders, the combustion pressure in each cylinder can be detected by providing the pressure detection unit for each cylinder. Thus, a stroke of each cylinder can be detected. That is, discrimination of the cylinder is enabled. As a result, the fault diagnosis device accurately detecting an abnormal condition of the crank angle sensor can be provided. In addition, since an abnormal condition of the crank angle sensor is detected based on a variation in a pressure detected with the pressure detection unit, an abnormal condition of the crank angle sensor can be detected even when an air intake amount is small.

The engine preferably has a plurality of cylinders. The state of the shaft is a state of a rotation angle of the shaft. When a pressure detected with the pressure detection unit is at least a predetermined pressure in a predetermined cylinder of the plurality of cylinders, the diagnosis unit diagnoses a fault in the detection device based on a rotation angle based on a variation in the pressure and a rotation angle detected with the detection device.

According to the present invention, a state of rotation is a rotation angle of the shaft (for example, the crankshaft). When a pressure detected with the pressure detection unit is at least a predetermined pressure in a predetermined cylinder of the plurality of cylinders, the diagnosis unit diagnoses, based on a rotation angle of the crankshaft based on a variation in the pressure and a rotation angle of the crankshaft detected with the detection device (for example, the crank angle sensor), a fault in the crank angle sensor. With this, the diagnosis unit can diagnose a fault in the crank angle sensor by, for example, comparing a rotation angle of the crankshaft based on a time at which the pressure detected with the pressure detection unit reaches a maximum value (for example, a peak time of the combustion pressure) in a predetermined cylinder, with a rotation angle of the crankshaft based on a reference position (for example, a position of a lacking tooth of a timing rotor) detected with the crank angle sensor.

The diagnosis unit preferably compares a rotation angle corresponding to a maximum value of the pressure detected with the pressure detection unit with a rotation angle detected with the detection device and diagnoses a fault in the detection device based on a result of the comparing.

According to the present invention, the diagnosis unit can compare a rotation angle of a shaft (for example, the crankshaft) corresponding to a time at which the pressure detected with the pressure detection unit reaches a maximum value (for example, a peak time of the combustion pressure) with a rotation angle of the crankshaft detected with the detection device (for example, the crank angle sensor) to diagnose a fault in the crank angle sensor based on a result of the comparing.

The detection device preferably detects a state of a camshaft of the engine.

According to the present invention, the detection device is a cam angle sensor detecting a state of rotation of the camshaft of the engine. Therefore, the fault diagnosis device can diagnose a fault in the cam angle sensor.

The detection device preferably detects a state of an output shaft of the engine.

According to the present invention, the detection device is a crank angle sensor detecting a state of rotation of the output shaft of the engine. Therefore, the fault diagnosis device can diagnose a fault in the crank angle sensor.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a construction of an engine of a vehicle having a fault diagnosis device according to a first embodiment of the present invention.

FIG. 2 is a flow chart of a program for diagnosing a fault in a crank angle sensor executed by the fault diagnosis device according to the first embodiment of the present invention.

FIGS. 3A-3H are time charts of signals output from respective sensors forming a fault diagnosis device according to a first or second embodiment of the present invention.

FIG. 4 is a flow chart of a program for diagnosing a fault in a cam angle sensor executed by the fault diagnosis device according to the second embodiment of the present invention.

### DESCRIPTION OF THE PREFERRED EMBODIMENTS

A fault diagnosis device according to each embodiment of the present invention will now be described referring to the drawings. In the description below, the same part having the same name and function is indicated with the same character, and the detailed description thereof will not be repeated.

### First Embodiment

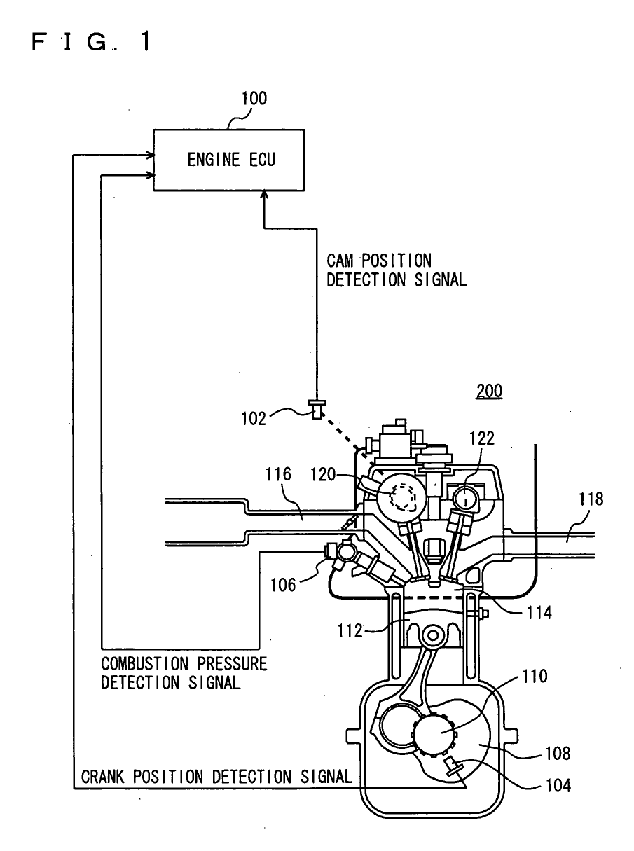

As shown in FIG. 1, an engine 200 of a vehicle provided with a fault diagnosis device according to this embodiment is constructed with an engine ECU (electronic control unit) 100, a cam angle sensor 102, a crank angle sensor 104, a combustion pressure sensor 106, a crankshaft 108, a timing rotor 110, a piston 112, a combustion chamber 114, an intake path 116, an exhaust path 118, and a camshaft 120. The fault diagnosis device according to this embodiment is achieved with a program executed by engine ECU 100.

In engine 200, air entering from intake path 116 is mixed with fuel injected from a fuel injector (not shown). Mixed air burns in combustion chamber 114 with ignition of an ignition plug (not shown). Piston 112 is pressed with a pressure generated by combustion, that is, a combustion pressure. With pressing of piston 112, crankshaft 108 is rotated via a crank mechanism. With rotation of crankshaft 108, camshafts 120 and 122 linked with a chain or the like are rotated. Then, with rotation of camshafts 120 and 122, a valve provided on an upper portion of combustion chamber 114 is opened or closed. With opening or closing of the valve, gas generated by combustion in combustion chamber 114 is exhausted to the outside through exhaust path 118.

Engine 200 has a plurality of cylinders. Though not specifically limited, engine 200 in this embodiment has, for example, 4 cylinders. Ignition is performed sequentially inside the 4 cylinders in a predetermined order.

Cam angle sensor 102 is provided opposite to a convex tooth portion provided on a timing rotor (not shown) fixed on camshaft 120. Cam angle sensor 102 transmits a cam position detection signal to engine ECU 100 corresponding to rotation of the timing rotor. More specifically, the cam position detection signal is transmitted to engine ECU 100 corresponding to a variation in an air gap between the tooth portion provided on the timing rotor and cam angle sensor 102.

Crank angle sensor 104 is provided opposite to timing rotor 110 fixed on crankshaft 108. Timing rotor 110 has a plurality of convex tooth portions. The plurality of tooth portions are provided with an angle corresponding to a predetermined spacing. Crank angle sensor 104 is formed with a coil or the like. When timing rotor 110 rotates, crank angle sensor 104 transmits a crank position detection signal to engine ECU 100 corresponding to an air gap between crank angle sensor 104 and the plurality of tooth portions.

Timing rotor 110 has a lacking tooth in a predetermined position. Engine ECU 100 detects a rotation angle of crankshaft 108 using a position of the lacking tooth detected with crank angle sensor 104 as a reference position.

Combustion pressure sensor 106 is provided in combustion chamber 114 of each of the 4 cylinders. A combustion pressure inside combustion chamber 114 is detected with a piezoelectric element provided on combustion pressure sensor 106. Combustion pressure sensor 106 transmits to engine ECU 100 a combustion pressure detection signal corresponding to the combustion pressure detected. Since combustion pressure sensor 106 is provided on each of the 4 cylinders, a combustion pressure in each cylinder can be detected. Therefore, a stroke of each cylinder can be detected. That is, discrimination of the cylinder is enabled.

Engine ECU 100 receives various signals transmitted from cam angle sensor 102, crank angle sensor 104 and combustion pressure sensor 106. Engine ECU 100 is constructed with a CPU (central processing unit) (not shown) and a memory (not shown) storing various data and programs.

The fault diagnosis device according to this embodiment diagnoses a fault in crank angle sensor 104 by detecting an abnormal variation in a physical value according to rotation of crankshaft 108, based on a state of a rotation angle of crankshaft 108 which is analyzed based on a variation in a combustion pressure detected with combustion pressure sensor 106, and a state of a rotation angle of crankshaft 108 which is detected with crank angle sensor 104. More specifically, in the engine having a plurality of cylinders, a variation in a pressure inside each cylinder due to combustion can be associated with a rotation angle of the crankshaft. Therefore, the present invention is characterized in that, engine ECU 100 diagnoses a fault in crank angle sensor 104 by associating a rotation angle of crankshaft 108 at a time crank angle sensor 104 detects the position of the lacking tooth of timing rotor 110 with a so-called peak time of the combustion pressure at which the combustion pressure detected with combustion pressure sensor 106 reaches a maximum value in a specific cylinder.

Engine ECU 100 compares a rotation angle of crankshaft 108 based on a variation in a combustion pressure detected with combustion pressure sensor 106 with a rotation angle of crankshaft 108 detected with crank angle sensor 104, and determines that crank angle sensor 104 is out of order when a difference between the rotation angle detected with crank angle sensor 104 and the rotation angle corresponding to the peak time of the combustion pressure in the specific cylinder is beyond a predetermined range. Here, a fault in crank angle sensor 104 means a state of a missing pulse or an excessive pulse due to a break or short circuit in the sensor.

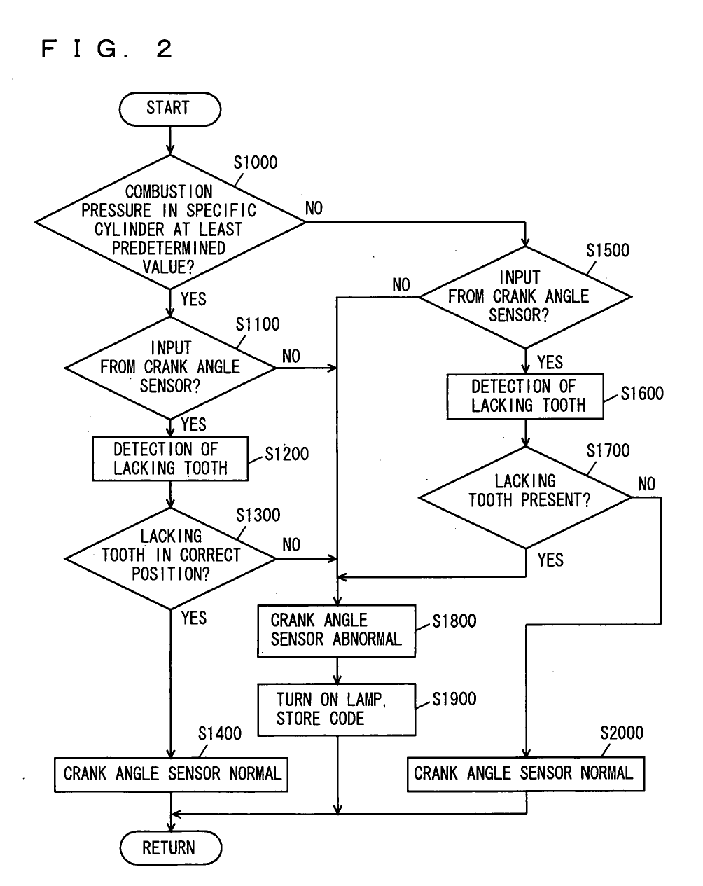

Referring to FIG. 2, a structure of a program for diagnosing a fault in crank angle sensor 104 executed in engine ECU 100 as the fault diagnosis device according to this embodiment will now be described.

In step 1000 (hereafter, “step” is abbreviated to “S”), engine ECU 100 determines as to whether a combustion pressure in a specific cylinder is at least a predetermined value or not. The specific cylinder is a predetermined cylinder of the 4 cylinders. The specific cylinder is, for example, a cylinder in which the combustion pressure reaches a peak value when the lacking tooth on timing rotor 110 is detected with crank angle sensor 104. The specific cylinder at a time when the combustion pressure reaches the peak value can be discriminated by providing combustion pressure sensor 106 to each of the 4 cylinders, as described above. In this embodiment, the time at which the combustion pressure reaches the peak value is a time at which the combustion pressure reaches a maximum value. The time at which the maximum value is reached can be calculated based on a variation amount of the combustion pressure per unit time.

In S1100, engine ECU 100 determines as to whether there is an input from crank angle sensor 104 or not. That is, engine ECU 100 determines as to whether a crank position detection signal transmitted from crank angle sensor 104 is received or not. If there is an input from crank angle sensor 104(YES in S1100), then the process moves to S1200. If there is not (NO in S1100), then the process moves to S1800.

In S1200, engine ECU 100 detects the lacking tooth. In this embodiment, the lacking tooth is detected in engine ECU 100 based on a cycle of the crank position detection signal transmitted from crank angle sensor 104.

In S1300, engine ECU 100 determines as to whether the lacking tooth detected is in a correct position or not. That is, engine ECU 100 determines as to whether a difference between a rotation angle of crankshaft 108 based on the position of the lacking tooth detected with crank angle sensor 104 and a rotation angle of crankshaft 108 corresponding to the peak time of the combustion pressure at which the combustion pressure detected with combustion pressure sensor 106 reaches the maximum value is within a predetermined range or not. If the lacking tooth is in a correct position (YES in S1300), then the process moves to S1400. If it is not (NO in S1300), then the process moves to S1800.

In S1400, engine ECU 100 diagnoses that crank angle sensor 104 is operating normally. In S1500, engine ECU 100 determines as to whether there is an input from crank angle sensor 104 or not. If there is an input from crank angle sensor 104 (YES in S1500), then the process moves to S1600. If there is not (NO in S1500), then the process moves to S1800.

In S1600, engine ECU 100 detects the lacking tooth. Detection of the lacking tooth is similar to that in S1200 described above. Therefore, the detailed description thereof is not repeated here.

In S1700, engine ECU 100 determines as to whether there is the lacking tooth or not as a result of the detection of the lacking tooth. If there is the lacking tooth (YES in S1700), then the process moves to S1800. If there is not (NO in S1700), then the process moves to S2000.

In S1800, engine ECU 100 determines that crank angle sensor 104 is operating abnormally. That is, engine ECU 100 diagnoses that crank angle sensor 104 is out of order.

In S1900, engine ECU 100 turns on a warning lamp. Engine ECU 100 stores a fault code corresponding to a fault in crank angle sensor 104 in the memory. In S2000, engine ECU 100 diagnoses that crank angle sensor 104 is operating normally.

Operations of the fault diagnosis device according to this embodiment for diagnosing a fault in crank angle sensor 104 based on the structure and flow chart as described above will now be described.

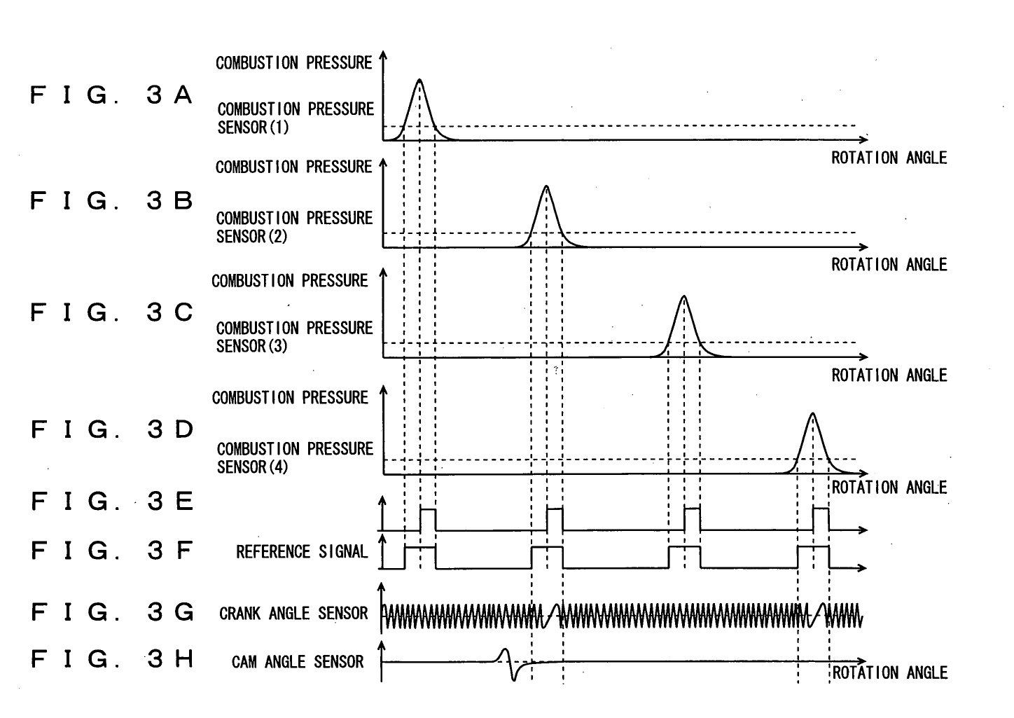

As shown in FIGS. 3A-3F, engine ECU 100 detects output signals of combustion pressure sensors (1)-(4) respectively provided on the 4 cylinders. When the combustion pressure is at least a predetermined value (YES in S1000) in each of two specific cylinders of the 4 cylinders provided with combustion pressure sensors (2) and (3), a determination is made as to whether there is an input from crank angle sensor 104 or not (S1100). As shown in FIG. 3F, engine ECU 100 generates a reference signal when the combustion pressure in each cylinder is at least a predetermined value. As shown in FIG. 3E, engine ECU 100 generates a peak signal when the combustion pressure in each cylinder reaches a peak value. The reference signal and the peak signal are not generated when the combustion pressure in each cylinder is less than the predetermined value. As shown in FIG. 3G, crank angle sensor 104 outputs a waveform corresponding to the tooth portions provided on timing rotor 110. A position of the lacking tooth can be detected by a cycle of the waveform between adjacent teeth output from crank angle sensor 104 becoming at least a predetermined length.

When there is no input from crank angle sensor 104 (NO in S1100), it is determined that crank angle sensor 104 is operating abnormally (S1800), and the warning lamp is turned on while the fault code is stored in the memory (S1900).

When there is an input from crank angle sensor 104 (YES in S1100), the lacking tooth is detected (S1200). If a difference between the rotation angle corresponding to the peak time of the combustion pressure and the rotation angle corresponding to the position of the lacking tooth detected with crank angle sensor 104 is at most a predetermined value in the specific cylinder, it is determined that the position of the lacking tooth detected is correct (YES in S1300) and that crank angle sensor 104 is operating normally (S1400).

The lacking tooth can be detected by determining as to whether the rotation angle corresponding to the position of the lacking tooth detected with crank angle sensor 104 when the peak signal is generated is a rotation angle within a predetermined range or not. Alternatively, engine ECU 100 may determine that the lacking tooth is in a correct position by detecting the lacking tooth while the combustion pressure in the specific cylinder is at least a predetermined value, that is, while the reference signal is generated.

When it is determined that the position of the lacking tooth detected is incorrect (NO in S1300), it is determined that crank angle sensor 104 is operating abnormally (S1800).

When the combustion pressure is less than a prescribed value in the specific cylinder (NO in S1000), a determination is made as to whether there is an input from crank angle sensor 104 or not (S1500). If there is no input from crank angle sensor 104 (NO in S1500), it is determined that crank angle sensor 104 is operating abnormally (S1800). If there is an input from crank angle sensor 104 (YES in S1500), then the lacking tooth is detected (S1600). If a waveform corresponding to the lacking tooth is detected with crank angle sensor 104 (YES in S1700), it is determined that crank angle sensor 104 is operating abnormally (S1800). If the waveform corresponding to the lacking tooth is not detected with crank angle sensor 104 (NO in S1700), it is determined that crank angle sensor 104 is operating normally (S2000).

As described above, the fault diagnosis device according to this embodiment is provided on the engine for diagnosing a fault in the crank angle sensor detecting a rotation angle of the crankshaft rotating with a driving force generated by combustion in the combustion chamber of the engine. The fault diagnosis device diagnoses a fault in the crank angle sensor by detecting an abnormal variation in a physical value according to rotation of the crankshaft, based on the combustion pressure sensor detecting a pressure inside the combustion chamber, a rotation angle analyzed based on a variation in the pressure detected with the combustion pressure sensor, and a rotation angle detected with the crank angle sensor. When the pressure detected with the combustion pressure sensor is at least a predetermined value, the engine ECU detects as to whether a predetermined input from the crank angle sensor is present or not. The engine ECU diagnoses that the crank angle sensor is out of order when the predetermined input is not present. More specifically, in the engine having a plurality of cylinders, a variation in the pressure inside each cylinder due to combustion can be associated with a rotation angle of the crankshaft. Therefore, the engine ECU diagnoses a fault in the crank angle sensor based on a rotation angle of the crankshaft analyzed based on a time at which the pressure detected with the combustion pressure sensor reaches a maximum value (for example, a peak time of the combustion pressure) in the predetermined cylinder, and a rotation angle of the crankshaft based on a reference position (for example, a position of the lacking tooth of the timing rotor) detected with the crank angle sensor. The engine ECU diagnoses that the crank angle sensor is out of order when a difference between the rotation angle detected with the crank angle sensor and the rotation angle based on the combustion pressure is beyond a predetermined range. In addition, when the engine has a plurality of cylinders, the engine ECU can detect the combustion pressure in each cylinder by providing the combustion pressure sensor for each cylinder. Thus, a stroke of each cylinder can be detected. That is, discrimination of the cylinder is enabled. As a result, the fault diagnosis device accurately detecting an abnormal condition of the crank angle sensor can be provided. In addition, since an abnormal condition of the crank angle sensor is detected based on a variation in the pressure detected with the combustion pressure sensor, an abnormal condition of the crank angle sensor can be detected even when an air intake amount is small.

### Second Embodiment

A fault diagnosis device according to a second embodiment will now be described. A construction of an engine of a vehicle having the fault diagnosis device according to this embodiment is similar to that of engine 200 described in the first embodiment. Therefore, the detailed description thereof is not repeated.

Though the fault diagnosis device according to the first embodiment is described as a device for diagnosing a fault in crank angle sensor 104, the present invention is not limited thereto. The fault diagnosis device according to this embodiment is provided on the engine for diagnosing a fault in a device detecting a state of a shaft rotating with a driving force generated by combustion in a combustion chamber of the engine. Therefore, the fault diagnosis device according to this embodiment may diagnose, for example, a fault in cam angle sensor 102.

The fault diagnosis device according to this embodiment diagnoses a fault in cam angle sensor 102 by detecting an abnormal variation in a physical value according to rotation of camshaft 120, based on a state of a rotation angle of camshaft 120 which is analyzed based on a variation in a combustion pressure detected with combustion pressure sensor 106, and a state of a rotation angle of camshaft 120 which is detected with cam angle sensor 102.

More specifically, a variation in a combustion pressure in a specific cylinder is associated with an input of a cam position detection signal from cam angle sensor 102. That is, engine ECU 100 determines as to whether cam angle sensor 102 is out of order or not based on presence of the input of the cam position detection signal from cam angle sensor 102, as shown in FIG. 3H, or absence thereof from a time at which a combustion pressure in the specific cylinder (the cylinder provided with the combustion pressure sensor (1)) becomes at least a predetermined value until a time at which a combustion pressure in a cylinder for successive combustion (the cylinder provided with the combustion pressure sensor (2)) changes.

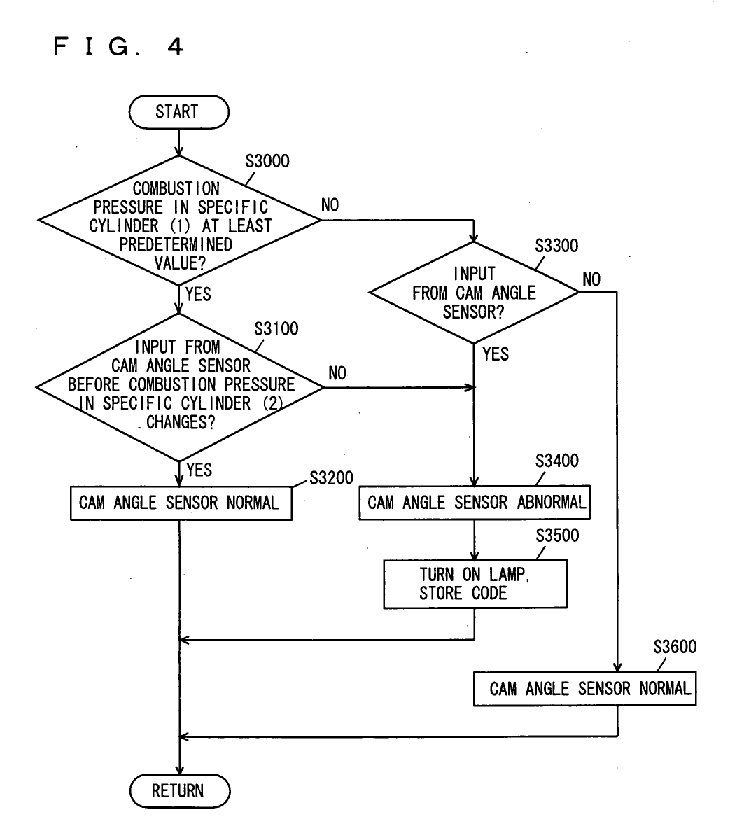

Referring to FIG. 4, a structure of a program for diagnosing a fault in cam angle sensor 102 executed in engine ECU 100 as the fault diagnosis device according to this embodiment will now be described.

In S3000, engine ECU 100 determines as to whether a combustion pressure in a specific cylinder (1) is at least a predetermined value or not. The specific cylinder (1) is a predetermined cylinder of the 4 cylinders. The specific cylinder (1) can be discriminated with the combustion pressure sensor provided on each of the 4 cylinders as described above. In this embodiment, the specific cylinder (1) is the cylinder provided with the combustion pressure sensor (1). When the combustion pressure in the specific cylinder (1) is at least the predetermined value (YES in S3000), the process moves to S3100. If it is not (NO in S3000), then the process moves to S3300.

In S3100, engine ECU 100 determines as to whether there is an input from cam angle sensor 102 or not before a combustion pressure in a specific cylinder (2) changes. The specific cylinder (2) is the cylinder of the 4 cylinder which is ignited subsequent to the specific cylinder (1). In this embodiment, the specific cylinder (2) is the cylinder provided with the combustion pressure sensor (2). Engine ECU 100 determines as to whether the cam position detection signal transmitted from cam angle sensor 102 is received or not before the combustion pressure in the specific cylinder (2) changes. If there is an input from cam angle sensor 102 before the combustion pressure in the specific cylinder (2) changes (YES in S3100), then the process moves to S3200. If there is not (NO in S3100), then the process moves to S3400. In S3200, engine ECU 100 determines that cam angle sensor 102 is operating normally.

In S3300, engine ECU 100 determines as to whether there is an input from cam angle sensor 102 or not. That is, engine ECU 100 determines as to whether the cam position detection signal transmitted from cam angle sensor 102 is received or not. If there is an input from cam angle sensor 102 (YES in S3300), then the process moves to S3400. If there is not (NO in S3300), then the process moves to S3600.

In S3400, engine ECU 100 determines that cam angle sensor 102 is operating abnormally. That is, cam angle sensor 102 is diagnosed to be out of order. In S3500, engine ECU 100 turns on a warning lamp and stores a fault code corresponding to a fault in cam angle sensor 102 in the memory. In S3600, engine ECU 100 determines that cam angle sensor 102 is operating normally.

Operations of the fault diagnosis device according to this embodiment for diagnosing a fault in cam angle sensor 102 based on the structure and flow chart as described above will now be described.

When the combustion pressure detected with the combustion pressure sensor (1), indicating an output waveform as shown in FIG. 3A, becomes at least a predetermined value (YES in S3000), a determination is made as to whether there is an input from cam angle sensor 102 or not before the combustion pressure detected with the combustion pressure sensor (2) changes (S3100), which combustion pressure indicates an output waveform as shown in FIG. 3B. If there is an input from cam angle sensor 102 as shown in FIG. 3H (YES in S3100), it is determined that cam angle sensor 102 is operating normally (S3200). If there is no input from the cam angle sensor (NO in S3100), it is determined that cam angle sensor 102 is operating abnormally (S3400), and the warning lamp is turned on while the fault code is stored in the memory (S3500). On the other hand, when the combustion pressure detected with the combustion pressure sensor (1) is less than the predetermined value (NO in S3000), a determination is made as to whether there is an input from cam angle sensor 102 (S3300). If there is an input from cam angle sensor 102 (YES in S3300), it is determined that cam angle sensor 102 is operating abnormally (S3400). If there is no input from cam angle sensor 102, on the other hand (NO in S3300), it is determined that cam angle sensor 102 is operating normally (S3600).

As described above, the fault diagnosis device according to this embodiment is provided on the engine and can diagnose a fault in the cam angle sensor detecting a rotation angle of the camshaft rotating with a driving force generated by combustion in the cylinder of the engine.

Although the present invention has been described and illustrated in detail, it is clearly understood that the same is by way of illustration and example only and is not to be taken by way of limitation, the spirit and scope of the present invention being limited only by the terms of the appended claims.

1. A fault diagnosis device provided on an engine for diagnosing a fault in a detection device detecting a state of a shaft rotating with a driving force generated by combustion in a combustion chamber of said engine, said fault diagnosis device comprising:
a pressure detection unit detecting a pressure inside said combustion chamber; and
a diagnosis unit diagnosing a fault in said detection device based on a state of the shaft analyzed based on a variation in a pressure detected with said pressure detection unit and a state of said shaft detected with said detection device.

2. The fault diagnosis device according to claim 1, wherein
said engine has a plurality of cylinders,
the state of said shaft is a state of a rotation angle of the shaft, and
when a pressure detected with said pressure detection unit is at least a predetermined pressure in a predetermined cylinder of said plurality of cylinders, said diagnosis unit diagnoses a fault in said detection device based on a rotation angle based on a variation in said pressure and a rotation angle detected with said detection device.

3. The fault diagnosis device according to claim 2, wherein
said diagnosis unit compares a rotation angle corresponding to a maximum value of the pressure detected with said pressure detection unit with a rotation angle detected with said detection device and diagnoses a fault in said detection device based on a result of comparing.

4. The fault diagnosis device according to claim 3, wherein
said detection device detects a state of an output shaft of said engine.

5. The fault diagnosis device according to claim 2, wherein
said detection device detects a state of a camshaft of said engine.

6. The fault diagnosis device according to claim 2, wherein
said detection device detects a state of an output shaft of said engine.

7. The fault diagnosis device according to claim 1, wherein
said detection device detects a state of a camshaft of said engine.

8. The fault diagnosis device according to claim 1, wherein
said detection device detects a state of an output shaft of said engine.

9. A fault diagnosis device provided on an engine for diagnosing a fault in a detection device detecting a state of a shaft rotating with a driving force generated by combustion in a combustion chamber of said engine, said fault diagnosis device comprising:
pressure detection means for detecting a pressure inside said combustion chamber; and
diagnosis means for diagnosing a fault in said detection device based on a state of the shaft analyzed based on a variation in a pressure detected with said pressure detection means and a state of said shaft detected with said detection device.

10. The fault diagnosis device according to claim 9, wherein
said engine has a plurality of cylinders,
the state of said shaft is a state of a rotation angle of the shaft, and
said diagnosis means includes means for, when a pressure detected with said pressure detection means is at least a predetermined pressure in a predetermined cylinder of said plurality of cylinders, diagnosing a fault in said detection device based on a rotation angle based on a variation in said pressure and a rotation angle detected with said detection device.

11. The fault diagnosis device according to claim 10, wherein
said diagnosis means includes means for comparing a rotation angle corresponding to a maximum value of the pressure detected with said pressure detection means with a rotation angle detected with said detection device and diagnosing a fault in said detection device based on a result of comparing.

12. The fault diagnosis device according to claim 11, wherein
said detection device detects a state of an output shaft of said engine.

13. The fault diagnosis device according to claim 10, wherein
said detection device detects a state of a camshaft of said engine.

14. The fault diagnosis device according to claim 10, wherein
said detection device detects a state of an output shaft of said engine.

15. The fault diagnosis device according to claim 9, wherein
said detection device detects a state of a camshaft of said engine.

16. The fault diagnosis device according to claim 9, wherein
said detection device detects a state of an output shaft of said engine.
